(19) United States
(12) Patent Application Publication
(10) Pub. No.: US 2011/0304610 A1
(43) Pub. Date: Dec. 15, 2011

(54) Design Support Apparatus and Design Support Method

(76) Inventors: Norikazu OKUDA, Tokyo (JP); Tadashi AKIYOSHI, Tokyo (JP)

(21) Appl. No.: 13/044,438

(22) Filed: Mar. 9, 2011

(30) Foreign Application Priority Data
Jun. 15, 2010 (JP) 2010-136506

(51) Int. Cl. G06T 15/00

(52) U.S. Cl. 345/419

(57) ABSTRACT

An embodiment of the design support apparatus includes: a component database in which 3D shape data of each component in equipment and 3D layout data of each component are stored; a design criteria database in which information which specifies a target component to be verified and determination criteria used for verification of a shortest inter-component distance between the target component and one or more peripheral components close to the target component are stored for each of the verification items; and a determination unit which extracts component data of the target component from the component database, extracts component data of each of the peripheral components corresponding to the extracted target component, and determines whether or not the inter-component distance between the target component and the peripheral components satisfies the determination criteria for each of the verification items.

### CROSS-REFERENCE TO RELATED APPLICATIONS

This application claims the benefit of priority of Japanese Patent Application No. 2010-136506, filed Jun. 15, 2010, the entire contents of which are incorporated herein by reference.

### FIELD

The present invention relates to a design support apparatus and a design support method for supporting a 3D mechanical design.

### BACKGROUND

In recent years, a 3D CAD (3-Dimensional Computer-Aided Design) is widely used in mechanical design of equipment such as a vehicle and an electronic device. In the 3D CAD, the shapes, sizes, and the like of various components used in the equipment are stored as a database. For example, the designer starts designing by fetching data of each component from the database and arranging the component data in each position inside the equipment.

In the course of designing, it is one of the important design verification items to check whether or not the arranged components contact (interfere) with each other.

As is well known, today's small electronic equipment, such as a notebook-type personal computer, moves more and more toward reduction in component size and toward high density mounting of components. The trend toward high density mounting of components involves diversified design verification items about mechanical design, and thus a simple determination of the presence or absence of inter-component interference is not sufficient. Further, the design verification requires increasing time and cost.

For example, consider the case in which the distance between the two components is measured in order to check whether or not the arrangement of designed components satisfies the design criteria. Conventionally, it is common that first, the generated 3D data is read and displayed on the screen, and then the position to be verified is visually found and determined. When the position to be verified is exposed outside the 3D data, the distance can be measured as is. However, the position to be verified is inside the 3D data, it is necessary to generate a 2D cross-sectional drawing including the position from the 3D data and manually measure the distance on the cross section. Then, a determination is made as to whether or not the measured distance satisfies the design criteria. Such a series of operations from determination of verification positions up to distance measurement and determination based on the design criteria is repeated until all verification positions are covered. Thus, the conventional design verification using a 3D CAD (design support apparatus) requires a lot of time and efforts.

In light of this, what is needed is a design support apparatus and a design support method which can efficiently perform design verification and handle diversified design verification items.

### BRIEF DESCRIPTION OF THE DRAWINGS

FIG. 1 illustrates a configuration example of a design support apparatus according to an embodiment;

FIGS. 2A to 2C describe an example of a conventional verification method;

FIG. 3 is flowchart illustrating an example of an inter-component distance verification method according to the present embodiment;

FIG. 4 is a schematic drawing of design criteria data stored in a design criteria database;

FIG. 5 is a perspective view illustrating an example of a component layout to be verified;

FIG. 6A is a top view, FIG. 6B is a front view, and FIG. 6C is a right side view of a component layout to be verified;

FIG. 7 illustrates a first display example of a determination result;

FIGS. 8A to 8C illustrate a second display example of a determination result; and

FIG. 9 illustrates a display example of a selection screen and a change screen of design criteria data.

### DETAILED DESCRIPTION

An embodiment of the design support apparatus comprises: a component database in which 3D shape data of each component in equipment and 3D layout data of each component are stored as component data for each component; a design criteria database, which is a database in which a plurality of verification items can be stored, and in which information which specifies a target component to be verified and determination criteria used for verification of a shortest inter-component distance between the target component and one or more peripheral components close to the target component are stored for each of the verification items; and a determination unit which extracts component data of the target component from the component database, extracts component data of each of the peripheral components corresponding to the extracted target component, and determines whether or not the inter-component distance between the target component and the peripheral components satisfies the determination criteria for each of the verification items.

A design support apparatus 1 and a design support method according to an embodiment of the present invention will be described by referring to accompanying drawings.

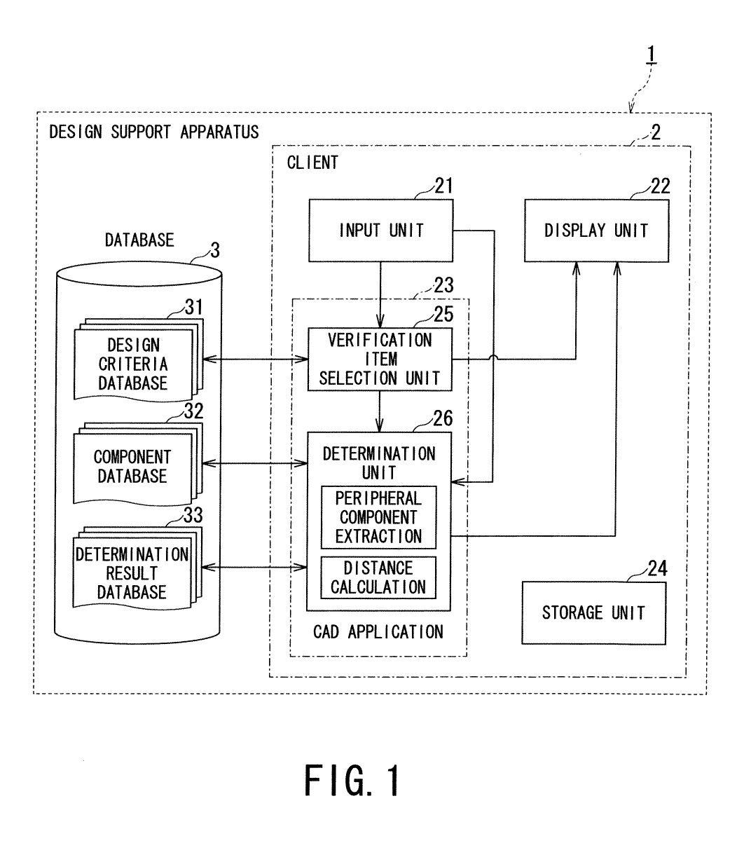

FIG. 1 is a block diagram illustrating a configuration example of the design support apparatus 1. The design support apparatus 1 includes a client 2 configured of a personal computer or the like and a database 3.

The client 2 is a computer configured to include an input unit 21 such as a keyboard and a mouse, a display unit 22 having a display panel and the like, a storage unit 24 including an HDD and the like, and a CPU (processor) (not illustrated), and the like. The CPU can execute CAD application software 23. The design support apparatus 1 according to the present embodiment is configured to allow the CAD application software 23 to execute each function of a verification item selection unit 25, a distance calculation unit 26, and a determination unit 27 described later.

The database 3 includes a design criteria database 31, a component database 32, and a determination result database 33 as its detailed configuration.

According to the configuration illustrated in FIG. 1, the client 2 is configured separately from the database 3 so as to allow the database 3 to be accessed from a plurality of clients 2. Alternatively, a storage unit 24 in the client 2 is configured to have the same function that the database 3 has.

In general, the mechanical design using the CAD application software 23 is such that component data about the shape and the like of a component for use in equipment such as an electronic device is preliminarily stored in a component database 32, and necessary component data is read from the component database 32 as needed and arranged in an appropriate position in the equipment. Moreover, the mechanical design of an equipment-specific component such as a support member of a component and a case for storing part or all of the components is also performed using the CAD application software 23. The layout data of the component subjected to layout design and the shape data of the support member, the case, and the like are stored again in the component database 32.

The high density mounting design is such that not only the inter-component distance is shortened but also the component layout is performed three-dimensionally. Therefore, it is very important to verify the presence or absence of inter-component interference after or in the middle of design. Moreover, it is very important not only to simply verify the presence or absence of inter-component interference, but also to verify whether or not the inter-component distance matches predetermined design criteria. For example, a moving component such as a mechanical switch needs to be verified to check whether or not the shortest distance to the surrounding components is determined in consideration of the movement of the moving part of the switch. Further, when a screw and a boss are arranged, it is required to sufficiently verify whether or not the layout ensures a predetermined screw-in amount.

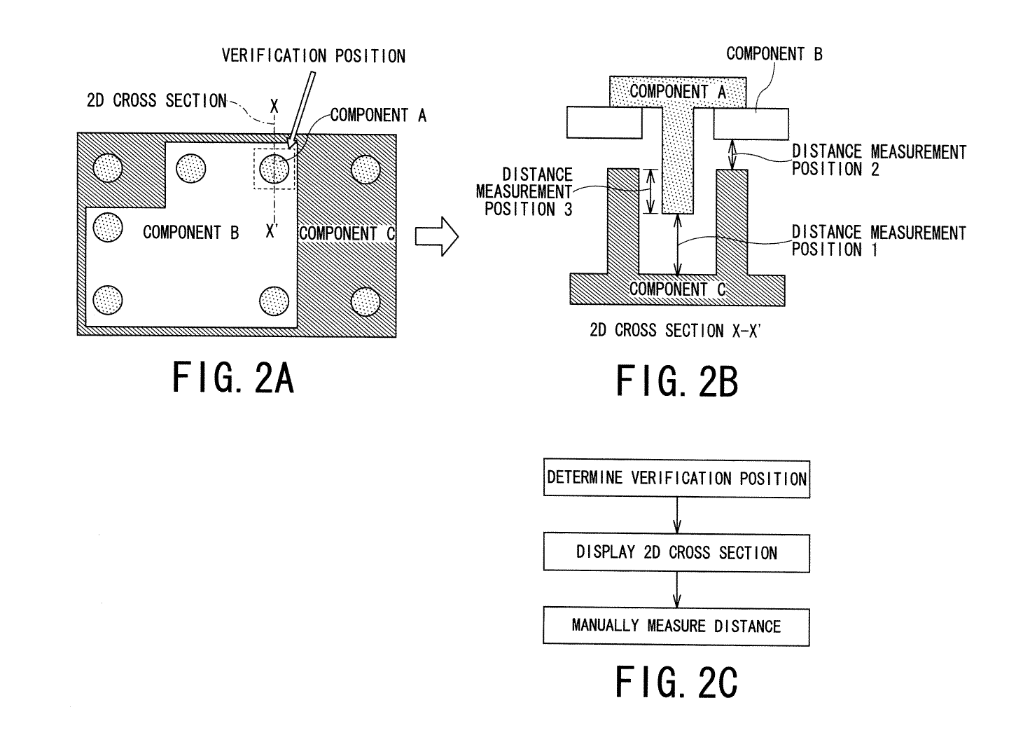

FIGS. 2A to 2B illustrate an example of verification work using conventional CAD application software. FIG. 2A is a top view schematically illustrating part of CAD data of an electronic device. In the present embodiment, a plate-like component B is placed on part of a plate-like component C and a component A is placed on the component B so as to pass through thereon. The component C is, for example, a printed circuit board having a boss portion and the component A is a screw.

Only the top view of FIG. 2A is not sufficient to verify the distance between the components A, B, and C. In light of this, conventionally, verification is performed using a flow as illustrated in FIG. 2C. More specifically, first, a verification position is determined and then a 2D cross section X-X′ is displayed as illustrated in FIG. 2B. Then, the distances to be verified are manually measured. For example, when a distance measurement position 1 is measured, first, a distal surface of the component A is selected by a pointer or the like and then an internal bottom surface of the component C is selected. Then, the distance between the two surfaces is displayed and measured. Then, when a distance measurement position 2 is measured, a rear surface of the component B and an upper surface of the boss portion of the component C are selected by a pointer or the like. Then, the distance between the two surfaces is measured. Thus, the conventional verification work using CAD application software takes a lot of time and efforts.

In contrast to this, the design support apparatus 1 according to the present embodiment provides an efficient verification of inter-component distance by greatly automating the verification process.

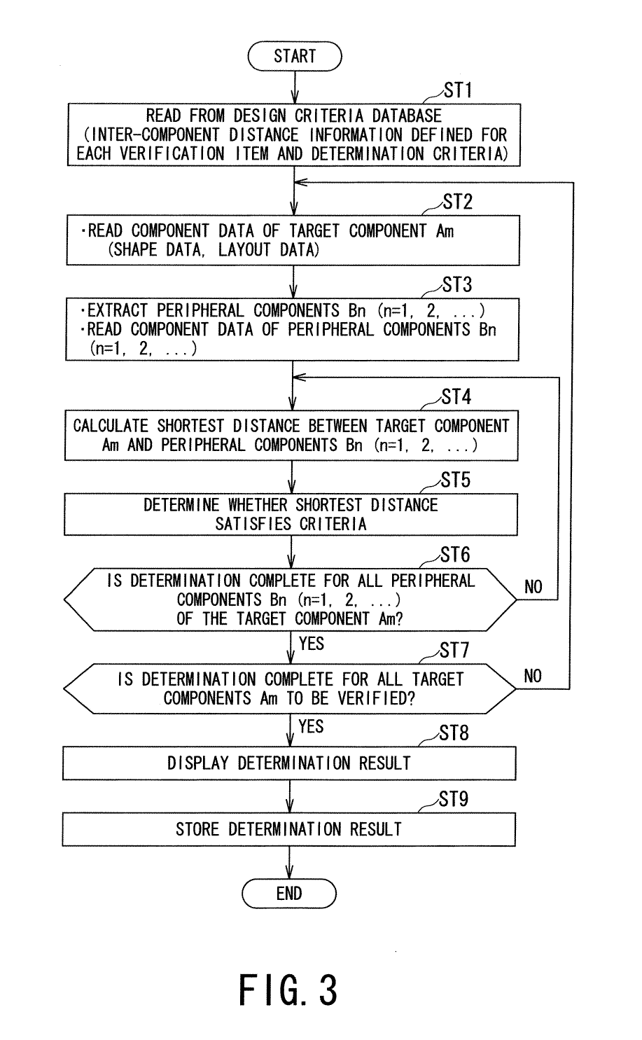

FIG. 3 is flowchart illustrating an example of an inter-component distance verification method performed by the design support apparatus 1 according to the present embodiment. One of the features of this verification method is that a database called a design criteria database is provided in advance, a verification procedure is automatically performed based on the design criteria database, and whether or not the inter-component distance is acceptable is automatically determined based on the determination criteria stored in the design criteria database.

First, in step ST1, the verification item selection unit 25 reads design criteria data from the design criteria database 31 of the database 3. As described later, a user may generate the design criteria data by using the design support apparatus 1, and store the design criteria data in the design criteria database 31. The user may also change or update the design criteria data read from the design criteria database 31.

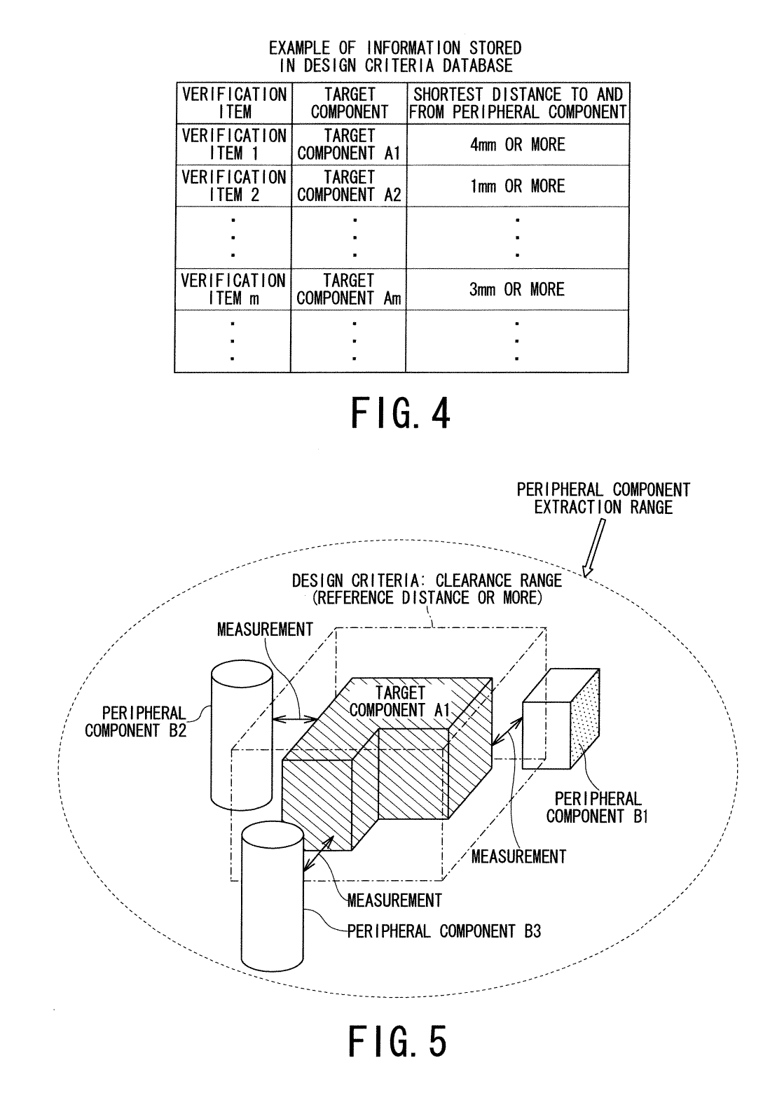

FIG. 4 illustrates an example of the design criteria data. The design criteria data is a description of a plurality of verification items and includes information which specifies a component to be verified, namely, a target component for each verification item and determination criteria used for verification of the shortest inter-component distance between the target component and one or more peripheral components close to the target component. The determination criteria are generally such that when the inter-component distance between the target component and the peripheral component is equal to or greater than a reference distance (clearance), the distance is determined to be acceptable, but the determination criteria are not always limited to this. For example, the determination criteria may be such that when the inter-component distance is within a range (e.g., in a range from 1 mm to 3 mm), the distance is determined to be acceptable.

In an example of FIG. 4, a target component A1 is specified as the verification item 1, and the shortest distance between the target component A1 and the peripheral component is specified as 4 mm or more. Further, a target component A2 is specified as the verification item 2, and the shortest distance between the target component A2 and the peripheral component is specified as 1 mm or more.

Now, by referring back to FIG. 3, in step ST2, component data of the corresponding target component Am (m corresponds to the verification item number) is extracted and read from the component database 32 for each verification item of the design criteria data. The component data to be read includes shape data and layout data of the target component.

Then, in step ST3, peripheral components Bn (n=1, 2, . . . ) of the target component Am are extracted and the shape data and the layout data of the extracted peripheral components Bn (n=1, 2, . . . ) are read from the component database 32.

FIG. 5 illustrates an example in which three peripheral components (peripheral component B1, peripheral component B2, and peripheral component B3) are located around the target component A1. The target component A1 is a component specified by the design criteria database 31. An extraction range with a predetermined size around the specified target component A1 is preset and components within the extraction range are extracted as the peripheral components. The number of peripheral component may be one or more.

In step ST4, the shortest distance between the target component Am and the peripheral components Bn (n=1, 2, . . . ) is calculated. More specifically, the shape data and the layout data of the target component Am and the peripheral component Bn are used to search each surface of the target component Am and the peripheral component Bn to determine each of the closest regions. Then, the distance between the determined closest regions is calculated and determined as the shortest inter-component distance. Here, the region refers to a specific point, a specific edge, a specific surface, or the like.

In step ST5, a determination is made as to whether or not the calculated shortest inter-component distance satisfies the determination criteria. More specifically, a determination is made as to whether or not the calculated shortest inter-component distance is equal to or greater than the reference distance specified as the design criteria data.

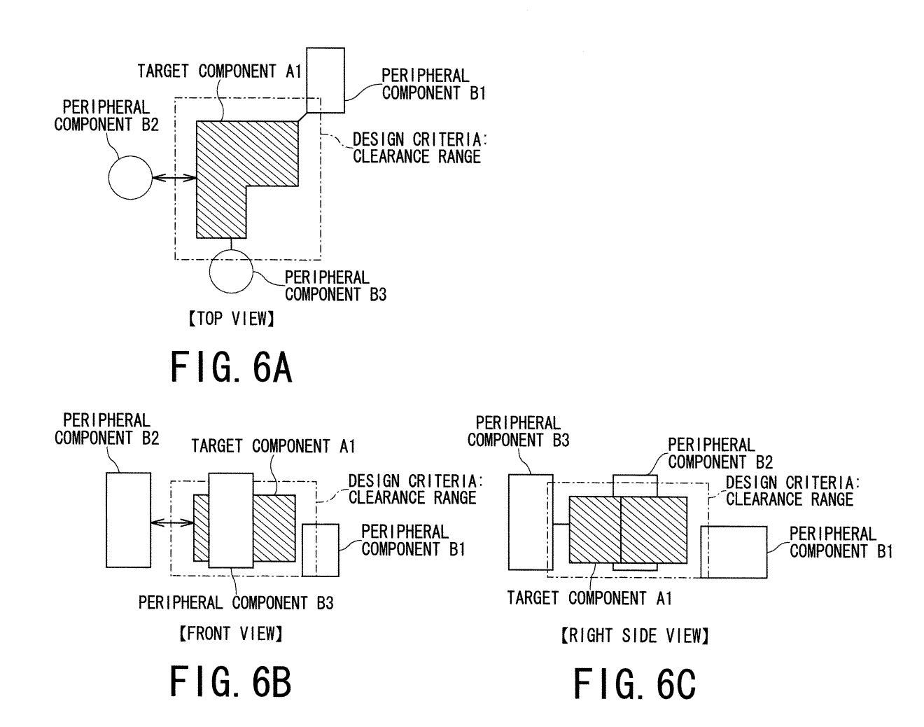

FIGS. 6A to 6C illustrate a positional relationship of the target component A1 and the three peripheral components (peripheral component B1, peripheral component 52, and peripheral component 83) illustrated in FIG. 5. FIG. 6A is a top view, FIG. 6B is a front view, and FIG. 6C is a right side view.

In the example of FIGS. 6A to 6C, the distance between an edge on the right back corner of the target component A1 and the peripheral component B1 is equal to or less than the reference distance (clearance) and thus does not satisfy the determination criteria. In addition, the distance between a front surface of the target component A1 and the peripheral component 53 is equal to or less than the reference distance (clearance) and thus does not satisfy the determination criteria. Meanwhile, the distance between the target component A1 and the peripheral component 22 is equal to or greater than the reference distance (clearance) and thus satisfies the determination criteria.

If the determination completes for all peripheral components Bn (n=1, 2, . . . ) around the target component Am (step ST6: YES), and further if the determination completes for all target components Am (m=1, 2, . . . ) to be verified (step ST7: YES), the process moves to step ST8, in which the determination result is displayed.

The design support apparatus 1 according to the present embodiment displays the shape and the layout of each component in the equipment to be designed on the display unit 22 as a 3D image or a 2D image in such a manner that only the components determined not to satisfy the determination criteria are displayed and the components determined to satisfy the determination criteria are automatically erased and hidden.

Today's electronic equipment includes a large number of small components which are three-dimensionally overlapped with each other and mounted at high density. Thus, in order to identify the components determined not to satisfy the determination criteria, it is necessary to erase the surrounding component images. However, in order to erase the images of unwanted components, the conventional CAD application software requires the user to specify the components one at a time to erase them. In contrast to this, the design support apparatus 1 according to the present embodiment displays only the components determined not to satisfy the determination criteria, and thus the user (designer) can very efficiently identify or find the necessary images (images of the components required for design change).

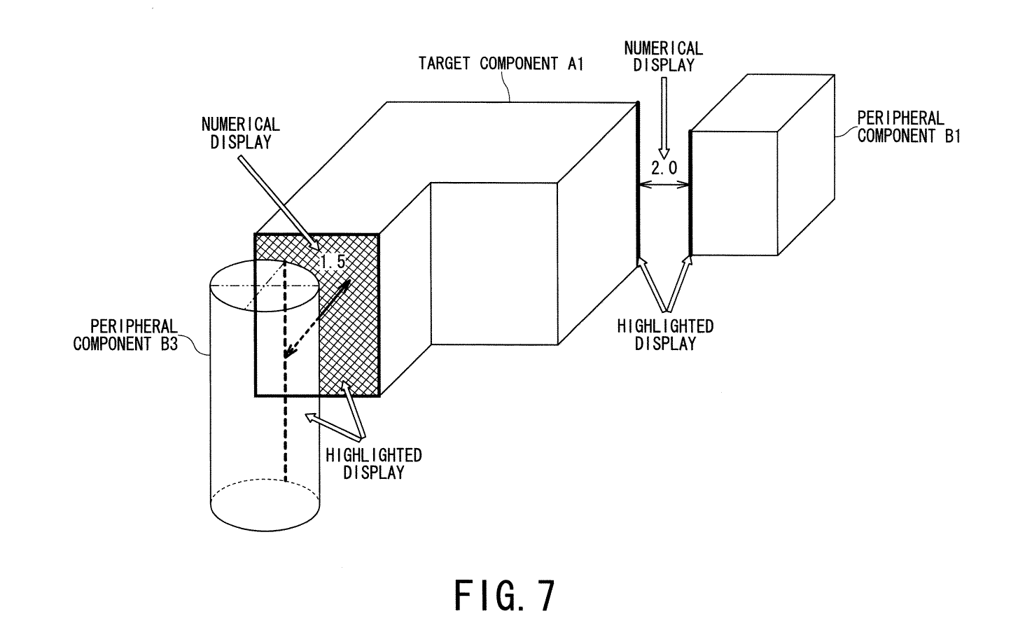

FIG. 7 illustrates a first display example of the determination result. As shown in the example of FIGS. 6A to 6C, among the peripheral components around the target component A1, the peripheral components B1 and B3 are determined not to satisfy the determination criteria, while the peripheral component B2 is determined to satisfy the determination criteria. Thus, only the peripheral component B1 and B3 are displayed and the peripheral component B2 is not displayed.

In addition, as illustrated in FIG. 7, the design support apparatus 1 according to the present embodiment not only displays the component images which do not satisfy the determination criteria but also highlight-displays the specific regions not satisfying the determination criteria. In the example of FIG. 7, since the distance between an edge on the right back corner of the target component A1 and the an edge on the left front corner of the peripheral component B1 does not satisfy the determination criteria, the corresponding two edges are highlight-displayed. Further, since the distance between a front surface of the target component A1 and the peripheral component B3 not satisfy the determination criteria, the front surface of the target component A1 and the closest region of the peripheral component 53 are highlight-displayed. The highlighted display allows the designer to instantly confirm the distance between which region and which region does not satisfy the determination criteria.

Further, as illustrated in FIG. 7, the design support apparatus 1 according to the present embodiment uses a bidirectional arrow to point to the two highlighted regions and displays a numerical value indicating the distance between the two regions. The designer can also get quantitative information from these displays.

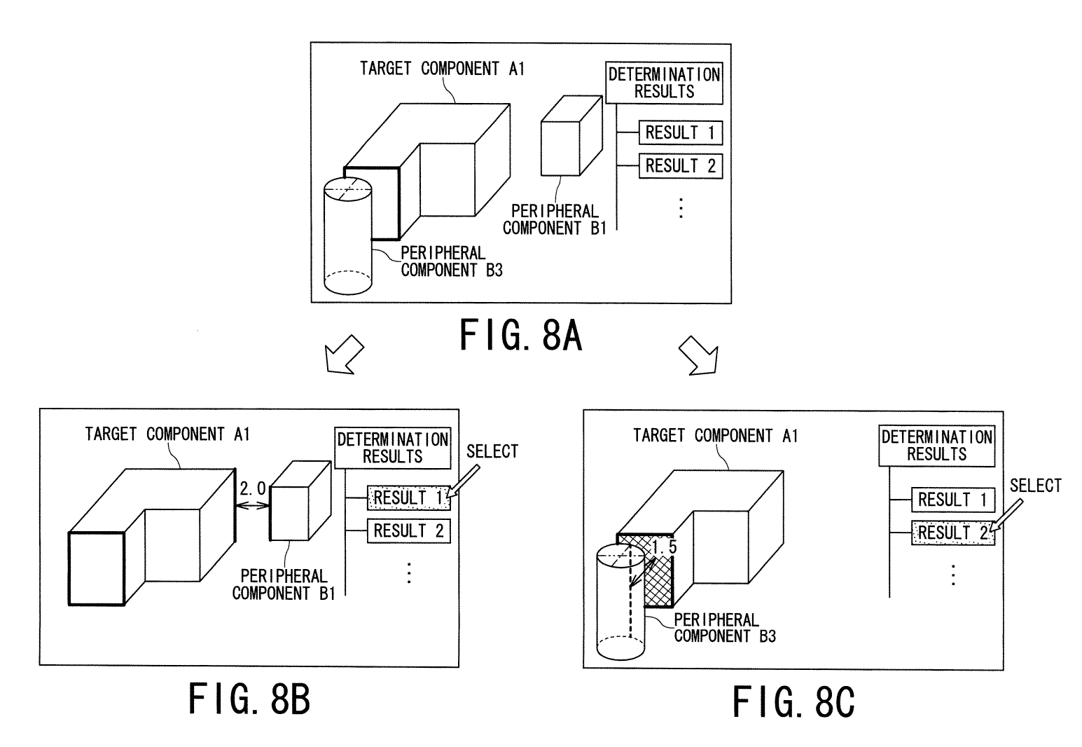

FIGS. 8A to 8C illustrate a second display example of the determination result. Even if only the components determined not to satisfy the determination criteria are displayed, but if a plurality of verification items do not to satisfy the determination criteria, the number of components to be displayed may increase. In light of this, as illustrated in FIGS. 8A to 8C, the design support apparatus 1 according to the present embodiment displays the verification items not satisfying the determination criteria on a side of component images, for example, in a tree-like structure.

FIG. 8A displays the image of the target component A1 and the images of all components not satisfying the determination criteria (in this example, the peripheral components 51 and B3).

Here, when the result 1 of the verification item 1 is selected by a pointer or the like, the screen moves to a screen of FIG. 8B. FIG. 8E displays only the target component A1 and the peripheral component B1 corresponding to the verification item 1. In FIG. 8B, a bidirectional arrow which points to the edges not satisfying the determination criteria and the distance in numeral are also displayed.

Then, when result 2 of the verification item 2 is selected, the screen moves to a screen of FIG. 8C. FIG. 8C displays only the target component A1 and the peripheral component 83, and highlight-displays the regions which do not satisfy the determination criteria of the verification item 2. Similarly, a bidirectional arrow which points the regions and the distance in numeral are also displayed.

Thus, even if there are a large number of peripheral components not satisfying the determination criteria, a selection of each verification item result from the tree display allows the unsatisfied peripheral components to be easily identified and the corresponding region and distance of the peripheral components to be visually verified in an easy manner.

Further, even if there are plural verification items in which plural target components and plural peripheral components do not satisfy the determination criteria, only a target component and a corresponding peripheral component can be extracted and displayed sequentially in a manner similar to the above.

The determination result can be stored in the determination result database 33 as an outcome in the course of design (step ST9 in FIG. 3). The designer concerned or other designers can call the determination results from the determination result database 33 any time to use them as the past design examples.

Note that, as described above, the client 2 can create and edit the content of the design criteria database 31.

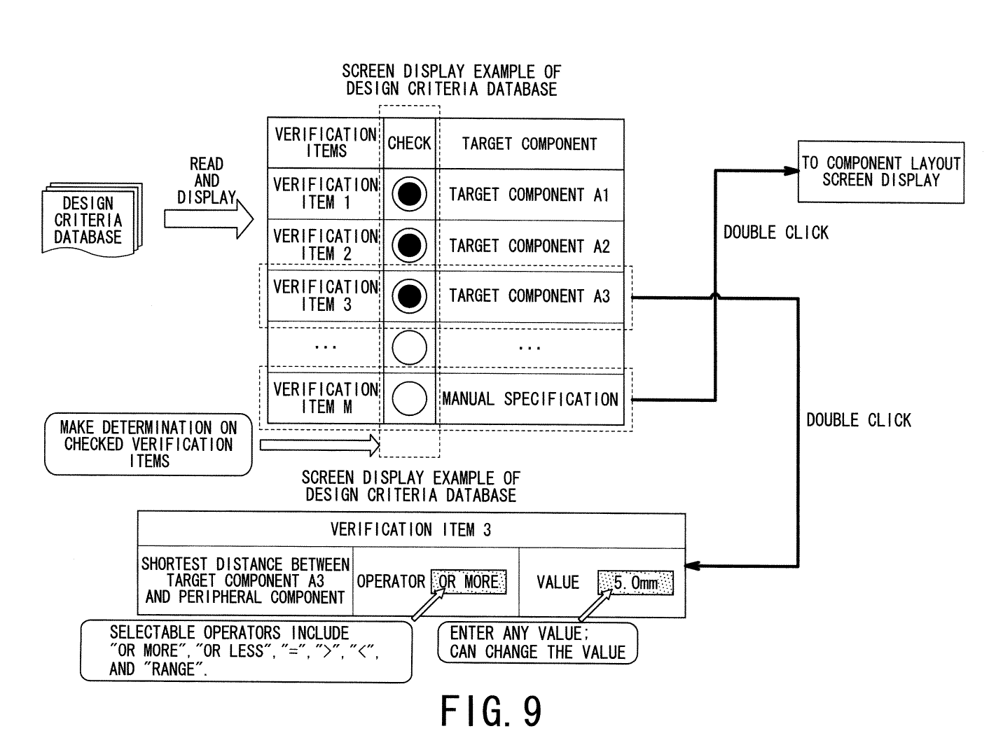

FIG. 9 illustrates a screen example in which the design criteria data is read from the design criteria database 31 and displayed on the display unit 22 of the client 2.

On this screen, a “check” column is provided between a “verification item” column and “target component” column. By checking a verification item in the “check” column (indicated by a black circle), the verification item is selected to be executed. In other words, the process following step ST2 of FIG. 3 is executed only for the selected verification items.

Moreover, when a specific verification item row is double-clicked, the detailed setting screen is opened as illustrated on the lower portion of FIG. 9, and the determination criteria corresponding to the verification item are displayed. The user may change the displayed determination criteria. The changed determination criteria are applied to execute the verification item and the changed determination criteria may also be stored in the design criteria database 31.

Examples of operators selectable for the determination criteria include “or more”, “or less”, “=”, “>”, “<”, and “range”. Thus, as described above, diversified determination criteria can be set. In addition, the value of the displayed determination criteria can also be changed.

Alternatively or in combination, as the verification item of the design criteria data, a specific target component is not automatically specified based on the database but instead “manual specification” can also be selected, which allows the user to specify any target component (see verification item M in FIG. 9). When the “manual specification” row is double-clicked and selected, the screen moves to a component layout screen on which each component in the equipment is arranged two-dimensionally or three-dimensionally. The user can specify a desired component on the screen by a pointer or the like and thereby can set the specified component as the target component A.

As described above, the design support apparatus 1 and the design support method according to the present embodiment can efficiently perform design verification on inter-component distance and can handle diversified design verification items.

While certain embodiments have been described, these embodiments have been presented by way of example only, and are not intended to limit the scope of the invention. Indeed, the novel apparatuses and units described herein may be embodied in a variety of other forms; furthermore, various omissions, substitutions and changes in the form of the apparatuses and units described herein may be made without departing from the spirit of the invention. The accompanying claims and their equivalents are intended to cover such forms or modifications as would fall within the scope and spirit of the invention.

What is claimed is:

1. A design support apparatus comprising:
a component database in which 3D shape data of each component in equipment and 3D layout data of each component are stored as component data for each component;
a design criteria database, which is a database in which a plurality of verification items are stored, and in which information which specifies a target component to be verified and determination criteria used for verification of a shortest inter-component distance between the target component and one or more peripheral components close to the target component are stored for each of the verification items; and
a determination unit which extracts component data of the target component from the component database, extracts component data of each of the peripheral components corresponding to the extracted target component, and determines whether or not the inter-component distance between the target component and the peripheral components satisfies the determination criteria for each of the verification items.

2. The design support apparatus according to claim 1, wherein
the determination criteria stored in the design criteria database determine whether or not the inter-component distance is equal to or less than a predetermined reference distance, and
the determination unit determines each region on a surface with the closest distance between a surface of the target component and a surface of each of the peripheral components, calculates the distance between the determined region on the target component surface and the determined region on each of the peripheral component surfaces, and determines that, if the calculated distance is equal to or less than the reference distance, the distance does not satisfy the determination criteria.

3. The design support apparatus according to claim 2, wherein
the determined region on the target component surface and the determined region on the peripheral component surface each are a specific point, a specific edge, or a specific surface.

4. The design support apparatus according to claim 1,
further comprising a display unit which displays results determined by the determination unit, wherein
the display unit displays the shape and the layout of each component in the equipment as a 3D image or a 2D image in such a manner that only the target component determined not to satisfy the determination criteria and the corresponding peripheral components are displayed and the other components are hidden.

5. The design support apparatus according to claim 2,
further comprising a display unit which displays results determined by the determination unit, wherein
the display unit displays the shape and the layout of each component in the equipment as a 3D image or a 2D image in such a manner that only the target component determined not to satisfy the determination criteria and the corresponding peripheral components are displayed and the determined region on the target component surface and the determined region on the peripheral component surface are highlight-displayed.

6. The design support apparatus according to claim 5, wherein
the display unit further displays an arrow connecting the determined region on the target component surface and the determined region on the peripheral component surface and a numerical value indicating the inter-component distance.

7. The design support apparatus according to claim 4, wherein
the display unit operates such that when a plurality of the verification items are determined that the inter-component distance does not satisfy the determination criteria, the plurality of verification items are displayed specifiably by a pointer and only the target component and the peripheral components corresponding to the verification items specified by the pointer are displayed.

8. The design support apparatus according to claim 5, wherein
the display unit operates such that when a plurality of the verification items are determined that the inter-component distance does not satisfy the determination criteria, the plurality of verification items are displayed specifiably by a pointer and only the target component and the peripheral components corresponding to the verification items specified by the pointer are displayed.

9. The design support apparatus according to claim 6, wherein
the display unit operates such that when a plurality of the verification items are determined that the inter-component distance does not satisfy the determination criteria, the plurality of verification items are displayed specifiably by a pointer and only the target component and the peripheral components corresponding to the verification items specified by the pointer are displayed.

10. The design support apparatus according to claim 1,
further comprising a storage unit which stores results determined by the determination unit.

11. The design support apparatus according to claim 1,
further comprising a verification item selection unit which selects a verification item as specified from the plurality of verification items stored in the design criteria database, wherein
the determination unit makes a determination for each of the selected evaluation items.

12. The design support apparatus according to claim 1, further comprising:
a display unit which displays the shape and the layout of each component in the equipment as a 3D image or a 2D image; and
a target component selection unit which selects a specific component specified by a pointer from the 3D image or the 2D image displayed on the display unit as the target component, wherein
when the target component is selected by the pointer, the determination unit extracts component data of each of the peripheral components corresponding to the selected target component and determines whether or not the inter-component distance between the selected target component and the peripheral component satisfies the determination criteria.

13. A design support method comprising:
storing 3D shape data of each component in equipment and 3D layout data of each component in a component database as component data for each component;
storing information which specifies a target component to be verified and determination criteria used for verification of a shortest inter-component distance between the target component and one or more peripheral components close to the target component for each of the verification items in a design criteria database in which a plurality of verification items are stored; and
extracting component data of the target component from the component database, extracting component data of each of the peripheral components corresponding to the extracted target component, and determining whether or not the inter-component distance between the target component and the peripheral component satisfies the determination criteria for each of the verification items.
